(19) United States
(12) Patent Application Publication
(10) Pub. No.: US 2016/0037534 A1
(43) Pub. Date: Feb. 4, 2016

(54) CHANNEL SWITCHING METHOD AND CHANNEL RECEPTION METHOD TO INCREASE SPECTRUM USE EFFICIENCY, AND CHANNEL SWITCHING APPARATUS AND CHANNEL RECEPTION APPARATUS USING THE SAME

(71) Applicant: Electronics and Telecommunications Research Institute, Daejeon (KR)

(72) Inventors: Joon Young JUNG, Daejeon (KR); Dong Joon CHOI, Daejeon (KR); Nam Ho HUR, Daejeon (KR)

(21) Appl. No.: 14/811,377

(22) Filed: Jul. 28, 2015

(30) Foreign Application Priority Data
Jul. 31, 2014 (KR) 10-2014-0098254
Feb. 17, 2015 (KR) 10-2015-0024156

(51) Int. Cl. H04W 72/04; H04L 29/06

(52) U.S. Cl. CPC H04W 72/0486; H04L 65/4076; H04W 72/0453

(57) ABSTRACT

Provided is a channel switching method and channel reception method to enhance spectrum use efficiency and a channel switching apparatus and channel reception apparatus using the same. The channel switching method may include extracting, based on received information associated with a virtual channel currently viewed by a user, broadcasting data on a corresponding virtual channel in a physical channel, determining communication data to be added to an idle frequency band in the physical channel including the extracted broadcasting data, and transmitting a transmission data stream generated based on communication data and broadcasting data included in the physical channel, wherein the physical channel comprises broadcasting data on a plurality of virtual channels and uses a predetermined frequency band.

### CROSS-REFERENCE TO RELATED APPLICATION

This application claims the priority benefit of Korean Patent Application No. 10-2014-0098254 filed on Jul. 31, 2014 and Korean Patent Application No. 10-2015-0024156 filed on Feb. 17, 2015 in the Korean Intellectual Property Office, the disclosures of which are incorporated herein by reference.

### BACKGROUND

1. Field of the Invention

Example embodiments of the present invention relate to a channel switching method and a channel reception method to increase a spectrum use efficiency, and a channel switching apparatus and a channel reception apparatus using the same, and more particularly, to a channel switching method and a channel reception method of selectively transmitting a currently viewed broadcasting channel and allocating resources of a non-transmitted channel for use in cable communication, thereby improving a frequency resource use efficiency.

2. Description of the Related Art

In a previous broadcasting network, a one-way service may be provided to simply transmit a broadcast signal. In contrast, a cable network may not only transmit the broadcast signal to a user but also provide a bidirectional broadcasting service such as the Internet, a voice over Internet protocol (VoIP) and the like using a cable modem. In a recent digital broadcasting network, a multichannel broadcasting service and a high-speed Internet may be provided based on a wideband frequency resource. Despite the wideband frequency resource, an available amount of frequency resources has reached the limit due to a high-capacity broadcasting service provided for a request for a more high-speed data communication service, and the like, for example, an ultra high-definition television (UHDTV).

A channel arrangement may differ for each cable broadcaster. In a general cable broadcasting network, a band between 5 and 42 megahertz (MHz) may be used for upstream transmission, and a band between 54 and 864 MHz or a band between 54 and 1002 MHz may be used for downstream transmission. The downstream transmission may be classified into analog broadcasting data transmission and digital broadcasting data transmission, each being performed based on a 6 MHz-unit channel.

In a digital broadcasting, a channel switching technique may be performed by transmitting channels selected by users in lieu of all channels. For example, frequency use efficiency may be enhanced by using an idle channel band remaining after the transmitting of the channels selected by the users, for other purposes, for example, a communication service. In general, during a broadcasting channel transmission, all currently viewed channels and non-viewed channels may be transmitted to a user, and the user may view a channel selected from the transmitted channels. While transmitting broadcasting data on the non-viewed channels may be disadvantageous in terms of frequency use efficiency. In contrast to the communication, such inefficiency may also be handled in the broadcasting in consideration of one-way transmission.

### SUMMARY

An aspect of the present invention provides a channel switching method and a channel reception method to enhance spectrum use efficiency, and a channel switching apparatus and a channel reception apparatus using the same. The channel switching method and the channel reception method may selectively transmit a broadcasting channel currently viewed by a user and allocating, for cable communication, resources of channels other than the transmitted broadcasting channel.

According to an aspect of the present invention, there is provided a channel switching method including extracting, based on received information associated with a virtual channel currently viewed by a user, broadcasting data on a corresponding virtual channel in a physical channel, determining communication data to be added to an idle frequency band in the physical channel including the extracted broadcasting data, and transmitting a transmission data stream generated based on communication data and broadcasting data included in the physical channel, wherein the physical channel includes broadcasting data on a plurality of virtual channels and uses a predetermined frequency band.

The communication data and the broadcasting data included in the physical channel may be transmitted in a form of a data packet.

The channel switching method may further include generating identification information of broadcasting data corresponding to the received information associated with the virtual channel currently viewed by the user, based on the information, wherein the extracting may include filtering broadcasting data matching the generated identification information among the broadcasting data included in the physical channel based on the identification information.

The identification information may be based on packet identification (PID) information of corresponding broadcasting data.

The determining may include verifying the idle frequency band of the physical channel, and selecting the communication data to be added to the verified idle frequency band.

The determining may include reducing a quantity of the communication data to be added to the idle frequency band in the physical channel in response to an increase in a quantity of broadcasting data to be transmitted in the physical channel, and increasing the quantity of the communication data to be added to the idle frequency band in the physical channel in response to a decrease in the quantity of broadcasting data to be transmitted in the physical channel.

The determining may include performing an addition of the broadcasting data in advance when simultaneous additions of the broadcasting data and the communication data to the idle frequency band in the physical channel are allowed.

According to another aspect of the present invention, there is also provided a channel reception method including receiving switching information on a virtual channel to be viewed by a user, and transmitting the received switching information to a channel switching apparatus.

According to still another aspect of the present invention, there is also provided a channel reception method including receiving a transmission data stream generated based on communication data and broadcasting data included in a physical channel, and extracting communication data included in the received transmission data stream.

The extracting may be performed based on PID information of the communication data.

According to yet another aspect of the present invention, there is also provided a channel switching apparatus including an extractor configured to extract, based on information on a virtual channel currently viewed by a user, broadcasting data on a corresponding virtual channel included in a physical channel, a determiner configured to determine communication data to be added to an idle frequency band in the physical channel including the extracted broadcasting data, and a transmitter configured to transmit a transmission data stream generated based on broadcasting data and communication data included in the physical channel, wherein the physical channel includes broadcasting data on a plurality of virtual channels and uses a predetermined frequency band.

The broadcasting data and the communication data included in the physical channel may be transmitted in a form of a data packet.

The channel switching apparatus may further include a generator configured to generate identification information for broadcasting data corresponding to the received information on the virtual channel currently viewed by the user, based on the information, wherein the extractor may be configured to filter broadcasting data matching the generated identification information among the broadcasting data included in the physical channel based on the identification information.

The identification information may be based on PID information of corresponding broadcasting data.

The determiner may be configured to verify the idle frequency band of the physical channel, and select communication data to be added to the verified idle frequency band.

The determiner may be configured to reduce a quantity of the communication data to be added to the idle frequency band in the physical channel in response to an increase in a quantity of broadcasting data to be transmitted in the physical channel, and configured to increase the quantity of the communication data to be added to the idle frequency band in the physical channel in response to a decrease in the quantity of broadcasting data to be transmitted in the physical channel.

The determiner may be configured to perform an addition of the broadcasting data in advance when simultaneous additions of the broadcasting data and the communication data to the idle frequency band in the physical channel are allowed.

According to further another aspect of the present invention, there is also provided a channel reception apparatus including a receiver configured to receive switching information on a virtual channel to be viewed by a user, and a transmitter configured to transmit the received switching information to a channel switching apparatus.

According to still another aspect of the present invention, there is also provided a channel reception apparatus including a receiver configured to receive a transmission data stream generated based on broadcasting data and communication data included in a physical channel, and an extractor configured to extract communication data included in the received transmission data stream.

The extractor may be configured to operate based on PID information of the communication data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a channel switching method performed in a general digital cable broadcasting according to a related art;

FIG. 2 illustrates a channel switching method according to an example embodiment of the present invention;

FIG. 3 illustrates a channel switching apparatus according to an example embodiment of the present invention;

FIG. 4 illustrates a channel switching method according to an example embodiment of the present invention;

FIG. 5 illustrates an example of a channel reception apparatus, for example, a set-top box, according to an example embodiment of the present invention; and

FIG. 6 illustrates another example of a channel reception apparatus, for example, a cable model, according to an example embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

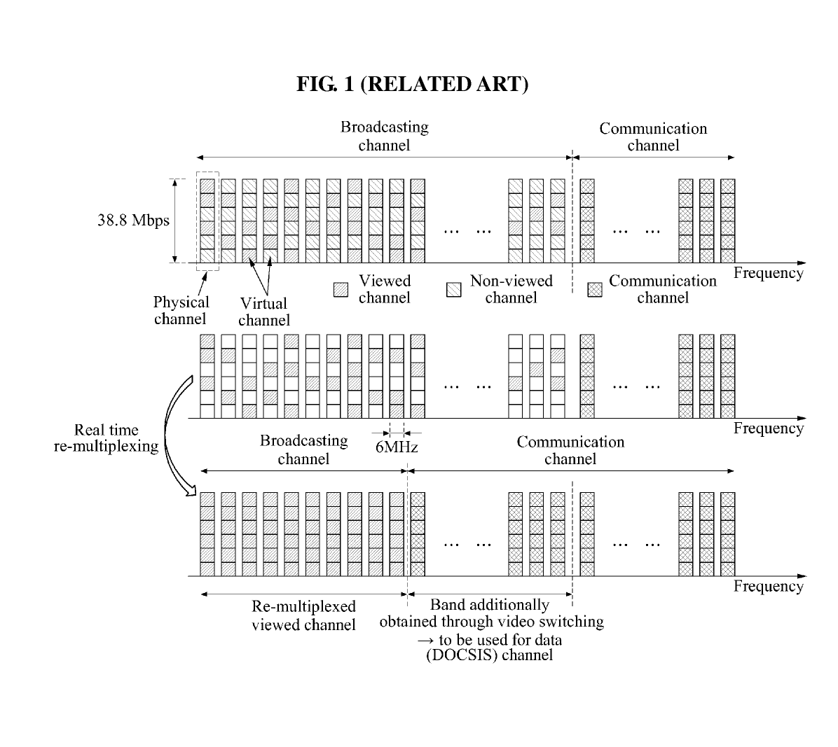

FIG. 1 illustrates a channel switching method performed in a general digital cable broadcasting according to a related art.

A digital cable broadcasting may be classified into a broadcasting channel and a communication channel. In each of the broadcasting channel and the communication channel, a physical 6 megahertz (MHz) band may be referred to as, for example, a physical channel. The physical channel may include broadcasting data associated with a plurality of virtual channels. In the digital cable broadcasting, the virtual channel may indicate a channel viewed by users. In an uppermost graph of FIG. 1, six virtual channels may be multiplexed and transmitted in a physical channel of a 6 MHz band. In general, the digital cable broadcasting may transmit all broadcasting data included in the physical channel of the broadcasting channel. Thus, in an example of FIG. 1, broadcasting data associated with a virtual channel that is not viewed by the users may be transmitted as well as broadcasting data viewed by the users.

As shown in a middle graph of FIG. 1, virtual channels currently viewed by the users may be included in the plurality of virtual channels of the physical channel. In an example of the middle graph, a relatively fewer number of virtual channels may be viewed by the users among the virtual channels of the physical channel. The present disclosure may propose a method of efficiently using frequency resources by assigning an idle frequency band corresponding to the virtual channel that is not viewed by the users in the physical channel, to be used for cable communication.

As shown in a bottom graph of FIG. 1, re-multiplexing may be performed on the virtual channels currently viewed by the users in the middle graph of FIG. 1. A result of the re-multiplexing may be allocated to physical channels from a preceding portion thereof. Remaining physical channels in the broadcasting channel may be used as communication channels in the cable communication. For example, a frequency resource may be efficiently used through a channel switching. Thus, in FIG. 1, the number of broadcasting channels for a broadcasting service may be reduced and the number of communication channels for a communication service may increase.

The channel switching method of FIG. 1 may ensure an efficient utilization of the frequency resource while having an adverse issue in realizing a channel switching system and a channel operation. The channel switching system based on the channel switching method may perform real time re-multiplexing on the virtual channel every time the virtual channel currently viewed by the user is changed. Thus, the channel switching system may include a re-multiplexer to manage each physical channel. Also, broadcasting data on the virtual channel input to each physical channel may be updated with broadcasting data on the virtual channel currently viewed by the user.

Accordingly, the channel switching system may include, for example, a routing apparatus for inputting broadcasting data on a virtual channel to the virtual channel of a corresponding physical channel. Also, in response to the virtual channel changed in the physical channel, a real time update may need to be performed on data such as a conditional access table (CAT), a program map table (PMT), and a program association table (PAT) corresponding to program specific information (PSI) resulting from the re-multiplexing, and signaling information, for example, physical channel frequency information and a program number in the physical channel, associated with virtual channels. As such, a complex system may need to be configured to support the channel switching method performed by the channel switching system of FIG. 1, which may lead to a high cost.

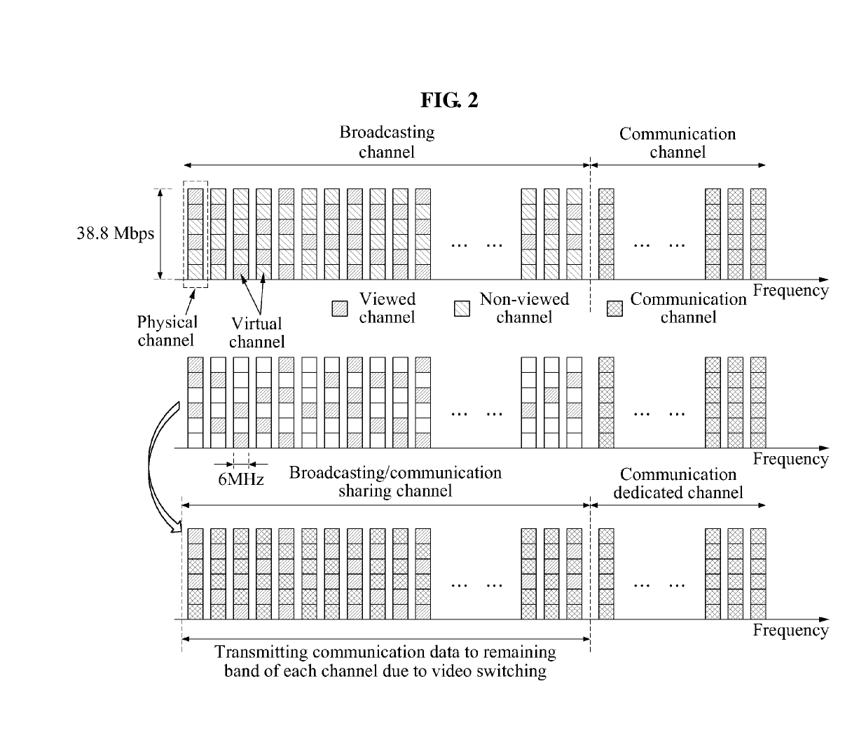

FIG. 2 illustrates a channel switching method according to an example embodiment of the present invention.

In a general channel switching system, each of a broadcasting service and a communication service may use a physical channel of a different frequency band. The present disclosure may propose a method of sharing an identical frequency band between a broadcasting service and a communication service. Also, in the general channel switching system, a real time re-multiplexing may be performed on a virtual channel based on information associated with a virtual channel that is currently viewed by a user.

In the present disclosure, transmission may not be performed for broadcasting data on a virtual channel that is not viewed by the user, among broadcasting data included in the physical channel. Additionally, the present disclosure may also propose a method in which transmission is performed by adding communication data to an idle frequency band of each physical channel to which broadcasting data is not transmitted. By using the method, in contrast to the aforementioned example of FIG. 1, the re-multiplexing may not be performed on physical channels to which the broadcasting data on the virtual channel is to be transmitted through a switching. Also, since the re-multiplexing is not performed on the physical channels, a physical channel change may not occur in the virtual channels and thus, channel signaling information may not be required.

Concisely, in the present disclosure, the same frequency use efficiency as that of FIG. 1 may be achieved by using an apparatus for extracting broadcasting data on a corresponding virtual channel based on information associated with a virtual channel that is currently viewed by a user and determining communication data to be added to an idle frequency band of a physical channel. Thus, in an example of FIG. 2, the communication service may be improved irrespective of increases and decreases in a number of broadcasting channels for the broadcasting service or a number of communication channels for the communication service.

In the example of FIG. 2, the broadcasting service and the communication service may be allowed to use the same physical channel based on the data over cable service interface specification (DOCSIS) 3.0 standard establishing a data transmission performed by combining various channels. For example, based on the DOCSIS 3.0 standard, a transmission side may transmit data by distributing the data to a plurality of physical channels, and a reception side may receive the data by combining a result of the distributing.

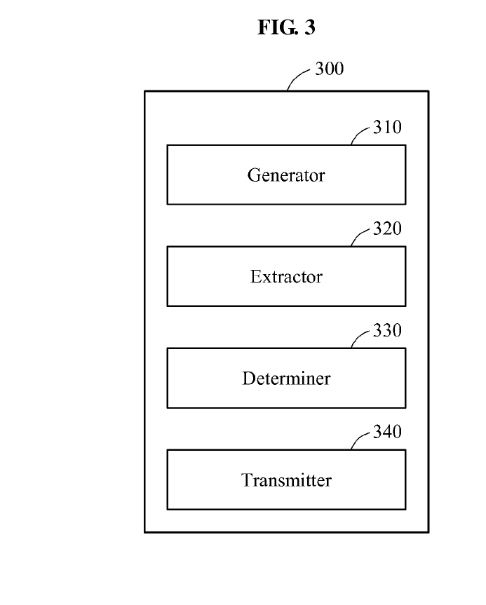

FIG. 3 illustrates a channel switching apparatus 300 according to an example embodiment of the present invention.

The channel switching apparatus 300 may include a generator 310, an extractor 320, a determiner 330, and a transmitter 340. The generator 310 may acquire information associated with a virtual channel currently viewed by a user, from the user. The information associated with the virtual channel acquired by the generator 310 may be received in real time every time the virtual channel currently viewed by the user is changed.

The generator 310 may generate filtering information used to identify broadcasting data on the virtual channel currently viewed by the user based on the acquired information associated with the virtual channel currently viewed by the user. In this example, the generated filtering information may be, for example, a packet identification (PID) value of the broadcasting data on the virtual channel currently viewed by the user.

In a digital cable broadcasting, a broadcasting service and a communication service may use the same physical layer transmission protocol. A physical layer transmission may indicate a procedure of generating a 6 MHz radio frequency (RF) signal by performing a quadrature amplitude modulation (QAM) modulation on broadcasting data and communication data, and transmitting the generated 6 MHz RF signal to a digital cable broadcasting network. In this example, a moving picture expert group (MPEG)-2 transport stream (TS) may be used as an input data format of a QAM modulator. The MPEG-2 TS may indicate a 188 byte MPEG-2 TS packet stream, and an MPEG-2 TS packet may include a 4 byte packet header and a 184 byte payload.

In general, the broadcasting data may be transmitted by using the MPEG-2 TS packet and the PID value included in a packet header may be used to identify broadcasting data, for example, video data and audio data, included in a corresponding packet. The communication data may also converted into MPEG-2 TS packets. In this example, 0x1FFE fixed as the PID value may be used to indicate that a corresponding MPEG-2 TS packet includes the communication data.

Accordingly, the generator 310 may use the PID value to generate the filtering information for extracting the broadcasting data on the virtual channel currently viewed by the user from the broadcasting data included in the physical channel.

The extractor 320 may extract the broadcasting data on the virtual channel currently viewed by the user from the broadcasting data included in the physical channel. In this example, the extractor 320 may use the filtering information generated by the generator 310 to extract the broadcasting data on the virtual channel currently viewed by the user. Based on the filtering information, the extractor 320 may extract broadcasting data having a PID value matching a corresponding PID value, and transfer the extracted broadcasting data to a transmission data buffer.

The determiner 330 may verify an idle frequency band in the physical channel, and select communication data to be added to the verified idle frequency band. The idle frequency band in the physical channel may be verified based on the broadcasting data included in the transmission data buffer. The transmission data buffer may include the broadcasting data on the virtual channel currently viewed by the user. Thus, the determiner 330 may verify a quantity of the broadcasting data included in the transmission data buffer, thereby determining a quantity of the communication data to be added to the verified idle frequency band.

For example, the determiner 330 may reduce the quantity of the communication data to be added to the verified idle frequency band according to an increase in a quantity of broadcasting data to be transmitted in the physical channel. Also, the determiner 330 may increase the quantity of the communication data to be added to the verified idle frequency band according to a decrease in the quantity of broadcasting data to be transmitted in the physical channel.

In this example, when simultaneous additions of the broadcasting data and the communication data to the idle frequency band in the physical channel are allowed, the determiner 330 may perform an addition of the broadcasting data in advance. For example, when the idle frequency band is present in the physical channel and the broadcasting data is additionally requested in response to a channel switching of the user, the determiner 330 may add the broadcasting data in advance, and then add the communication data to a remaining idle frequency band.

The transmitter 340 may transmit the broadcasting data on the virtual channel currently viewed by the user and the communication data added to the idle frequency band in the physical channel. The transmitter 340 may perform the QAM modulation on the transmission data stream including the communication data and the broadcasting data to be transmitted in the physical channel, and transmit the transmission data stream in a form of an RF signal.

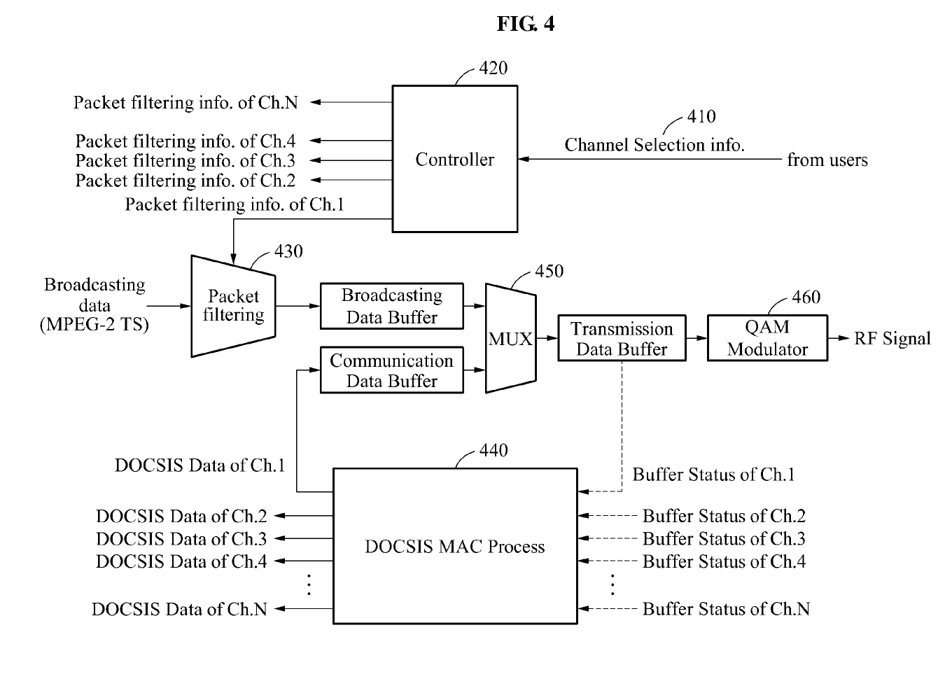

FIG. 4 illustrates a channel switching method according to an example embodiment of the present invention.

In operation 410, the channel switching apparatus 300 may receive, from the user, information associated with a virtual channel currently viewed by a user. In this example, the information associated with the virtual channel received from the user may be received in real time every time the virtual channel currently viewed by the user is changed.

In operation 420, the channel switching apparatus 300 may generate filtering information used to identify broadcasting data on the virtual channel currently viewed by the user based on the received information. In this example, the generated filtering information may be, for example, a PID value of the broadcasting data on the virtual channel currently viewed by the user.

The foregoing example may be based on a case in which information associated with a channel transmitted and received in a digital cable broadcasting is transferred in a form of a packet. In this example, a PID of the broadcasting data may be included in a packet header. For example, when the communication data is to be transferred, 0x1FFE fixed as a PID value may be used to indicate that a corresponding packet includes the communication data.

In operation 430, the channel switching apparatus 300 may extract the broadcasting data on the virtual channel currently viewed by the user from the broadcasting data included in each physical channel based on the filtering information generated in operation 420. For example, the channel switching apparatus 300 may extract broadcasting data included in the physical channel using the PID corresponding to the filtering information generated based on the broadcasting data on the virtual channel currently viewed by the user.

The extracted broadcasting data may be transferred to a transmission data buffer through a multiplexer (MUX). Thus, the transmission data buffer may include the broadcasting data on the virtual channel currently viewed by the user among the broadcasting data included in the physical channel.

In operation 440, the channel switching apparatus 300 may determine communication data to be added to an idle frequency band in the physical channel. In this example, the communication data to be added to an idle frequency band in the physical channel may be determined based on the broadcasting data included in the transmission data buffer. As an example, a virtual channel NO. 1 may be currently viewed by a user and a virtual channel NO. 2 may not be viewed by the user. The channel switching apparatus 300 may filter broadcasting data on the virtual channel NO. 1 and transfer the filtered broadcasting data to the transmission data buffer through the MUX while broadcasting data on the virtual channel NO. 2 is not filtered and transferred to the transmission data buffer. Thus, the channel switching apparatus 300 may select the communication data to be added to the idle frequency band in the physical channel based on a quantity of the broadcasting data on the virtual channel NO. 2 not currently viewed by the user.

In this example, the channel switching apparatus 300 may reduce the quantity of the communication data to be added to the idle frequency band in the physical channel according to an increase in a quantity of broadcasting data to be transmitted in the physical channel. Also, the channel switching apparatus 300 may increase the quantity of the communication data to be added to the idle frequency band in the physical channel according to a decrease in the quantity of broadcasting data to be transmitted in the physical channel.

In operation 450, the channel switching apparatus 300 may configure a transmission data stream including the communication data and the broadcasting data included in the physical channel by multiplexing the communication data and the broadcasting data.

In this example, when simultaneous additions of the broadcasting data and the communication data to the idle frequency band in the physical channel are allowed, the channel switching apparatus 300 may perform an addition of the broadcasting data in advance. For example, when the idle frequency band is present in the physical channel and the broadcasting data is additionally requested in response to a channel switching of the user, the channel switching apparatus 300 may perform the addition of the broadcasting data in advance, and then add the communication data to a remaining idle frequency band.

In operation 460, the channel switching apparatus 300 may output the transmission data stream generated in operation 450 in a form of an RF signal by performing the QAM modulation on the transmission data stream.

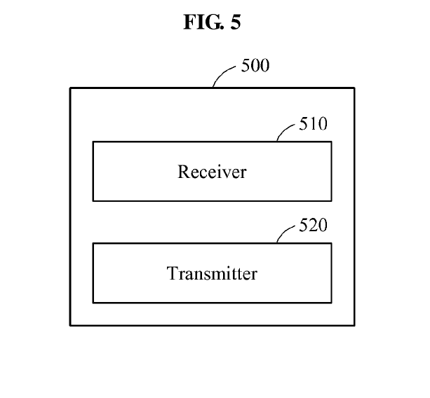

FIG. 5 illustrates a channel reception apparatus 500 according to an example embodiment of the present invention. In FIG. 5, the channel reception apparatus 500 may be, for example, a set-top box.

The channel reception apparatus 500 may include a receiver 510 and a transmitter 520. The channel reception apparatus 500 may receive an RF signal transmitted from the channel switching apparatus 300 and perform QAM demodulation on the received RF signal. Subsequently, the channel reception apparatus 500 may decode broadcasting data on a virtual channel selected by a user in a QAM demodulation output. Through this, the user may view the decoded broadcasting data.

The transmitter 520 may transmit switching information on a channel viewed by the user to the channel switching apparatus 300. By transmitting the switching information to the channel switching apparatus 300 in real time, the transmitter 520 may allow the channel switching apparatus 300 to extract broadcasting data on a virtual channel to be transmitted.

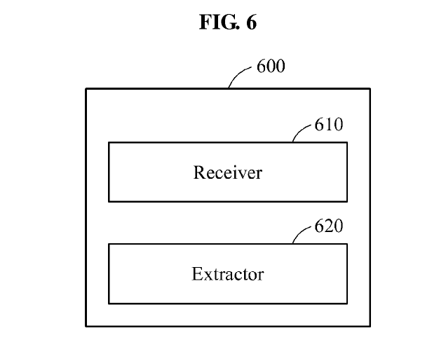

FIG. 6 illustrates a channel reception apparatus 600 according to an example embodiment of the present invention. In FIG. 6, the channel reception apparatus 600 may be, for example, a cable model.

The channel reception apparatus 600 may include a receiver 610 and an extractor 620. The receiver 610 may receive an RF signal transmitted from the channel switching apparatus 300 and perform QAM demodulation on the received RF signal. In this example, broadcasting data and communication data may be mixed in the RF signal on which the QAM demodulation is performed. In general, the communication data may be received through an independent physical channel and thus, a separate packet filtering may not be performed on the communication data. In the present disclosure, the broadcasting data and the communication data may be present in the same physical channel. Thus, the channel reception apparatus 600 may need to extract the communication data from the RF signal on which the QAM demodulation is performed.

The extractor 620 may extract the communication data from the RF signal on which the QAM demodulation is performed. In general, a cable modem may be configured to receive a communication data packet, for example, an MPEG-2 TS packet including a DOCSIS medium access control (MAC) frame. A PID of the MPEG-2 TS including the DOCSIS MAC frame may be fixed as, for example, 0x1FFE. Thus, the extractor 620 may extract a packet having a PID corresponding to 0x1FFE to verify the communication data from the RF signal on which the QAM demodulation is performed. Through this, a communication service may also be available when broadcasting data and communication data is mixed in a received signal.

According to an aspect of the present invention, it is possible to enhance frequency resource use efficiency by selectively transmitting a broadcasting channel currently viewed by a user and allocating, for cable communication, resources of non-transmitted channels other than the transmitted broadcasting channel.

According to another aspect of the present invention, it is possible to enhance frequency use efficiency by using a cost-effective method without need to configure a complex system.

The units described herein may be implemented using hardware components and software components. For example, the hardware components may include microphones, amplifiers, band-pass filters, audio to digital convertors, and processing devices. A to processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions to recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A channel switching method comprising:
extracting, based on received information associated with a virtual channel currently viewed by a user, broadcasting data on a corresponding virtual channel in a physical channel;
determining communication data to be added to an idle frequency band in the physical channel including the extracted broadcasting data; and
transmitting a transmission data stream generated based on communication data and broadcasting data included in the physical channel,
wherein the physical channel comprises broadcasting data on a plurality of virtual channels and uses a predetermined frequency band.

2. The method of claim 1, wherein the communication data and the broadcasting data included in the physical channel are transmitted in a form of a data packet.

3. The method of claim 1, further comprising:
generating identification information of broadcasting data corresponding to the received information associated with the virtual channel currently viewed by the user, based on the information,
wherein the extracting comprises filtering broadcasting data matching the generated identification information among the broadcasting data included in the physical channel based on the identification information.

4. The method of claim 3, wherein the identification information is based on packet identification (PID) information of corresponding broadcasting data.

5. The method of claim 1, wherein the determining comprises verifying the idle frequency band of the physical channel, and selecting the communication data to be added to the verified idle frequency band.

6. The method of claim 5, wherein the determining comprises reducing a quantity of the communication data to be added to the idle frequency band in the physical channel in response to an increase in a quantity of broadcasting data to be transmitted in the physical channel, and increasing the quantity of the communication data to be added to the idle frequency band in the physical channel in response to a decrease in the quantity of broadcasting data to be transmitted in the physical channel.

7. The method of claim 1, wherein the determining comprises performing an addition of the broadcasting data in advance when simultaneous additions of the broadcasting data and the communication data to the idle frequency band in the physical channel are allowed.

8. A channel reception method comprising:
receiving a transmission data stream generated based on communication data and broadcasting data included in a physical channel; and
extracting communication data included in the received transmission data stream.

9. The method of claim 8, wherein the extracting is performed based on packet identification (PID) information of the communication data.

10. A channel switching apparatus comprising:
an extractor configured to extract, based on information on a virtual channel currently viewed by a user, broadcasting data on a corresponding virtual channel included in a physical channel;
a determiner configured to determine communication data to be added to an idle frequency band in the physical channel including the extracted broadcasting data; and
a transmitter configured to transmit a transmission data stream generated based on broadcasting data and communication data included in the physical channel,
wherein the physical channel comprises broadcasting data on a plurality of virtual channels and uses a predetermined frequency band.

11. The apparatus of claim 10, wherein the broadcasting data and the communication data included in the physical channel are transmitted in a form of a data packet.

12. The apparatus of claim 10, further comprising:
a generator configured to generate identification information for broadcasting data corresponding to the received information on the virtual channel currently viewed by the user, based on the information,
wherein the extractor is configured to filter broadcasting data matching the generated identification information among the broadcasting data included in the physical channel based on the identification information.

13. The apparatus of claim 12, wherein the identification information is based on packet identification (PID) information of corresponding broadcasting data.

14. The apparatus of claim 10, wherein the determiner is configured to verify the idle frequency band of the physical channel, and select communication data to be added to the verified idle frequency band.

15. The apparatus of claim 14, wherein the determiner is configured to reduce a quantity of the communication data to be added to the idle frequency band in the physical channel in response to an increase in a quantity of broadcasting data to be transmitted in the physical channel, and configured to increase the quantity of the communication data to be added to the idle frequency band in the physical channel in response to a decrease in the quantity of broadcasting data to be transmitted in the physical channel.

16. The apparatus of claim 10, wherein the determiner is configured to perform an addition of the broadcasting data in advance when simultaneous additions of the broadcasting data and the communication data to the idle frequency band in the physical channel are allowed.
